(19) United States
(12) Patent Application Publication
(10) Pub. No.: US 2014/0225817 A1
(43) Pub. Date: Aug. 14, 2014

(54) Electronic Device with Variable Refresh Rate Display Driver Circuitry

(71) Applicant: Apple Inc., Cupertino, CA (US)

(72) Inventors: Chun-Yao Huang, Cupertino, CA (US); John Z. Zhong, Cupertino, CA (US); Kyung-Wook Kim, Cupertino, CA (US); Ming-Chin Hung, Cupertino, CA (US); Shih-Chang Chang, Cupertino, CA (US)

(73) Assignee: Apple Inc., Cupertino, CA (US)

(21) Appl. No.: 14/150,579

(22) Filed: Jan. 8, 2014

Related U.S. Application Data
(60) Provisional application No. 61/764,428, filed on Feb. 13, 2013.

(51) Int. Cl. G09G 3/36

(52) U.S. Cl. CPC G09G 3/3611
USPC 345/87

(57) ABSTRACT

A display may have an array of display pixels. The array may have rows. Each row of the display pixels may receive gate lines signals on a respective gate line. Gate driver circuitry may be used to drive gate line signals onto the gate lines. Each gate line may be coupled to a logic gate in the gate driver circuitry. The logic gates may each be coupled to a respective latch. A termination block in the gate driver circuitry may have a termination block latch and a termination block logic gate. Signal lines may be used to distribute clock signals from display driver circuitry to the logic gates. Respective signal lines may also be used to distribute a pixel charging initiation signal to a latch in the first row of the array and a pixel charging termination signal to the termination block latch.

This application claims priority to U.S. provisional patent application No. 61/764,428 filed Feb. 13, 2013, which is hereby incorporated by reference herein in its entirety.

### BACKGROUND

This relates generally to electronic devices and, more particularly, to displays for electronic devices.

Electronic devices such as computers and cellular telephones are generally provided with displays. Displays such as liquid crystal displays contain a thin layer of liquid crystal material. Color liquid crystal displays include color filter layers. The layer of liquid crystal material in this type of display is interposed between the color filter layer and a thin-film transistor layer. Polarizer layers may be placed above and below the color filter layer, liquid crystal material, and thin-film transistor layer.

When it is desired to display an image for a user, display driver circuitry applies signals to a grid of data lines and gate lines within the thin-film transistor layer. These signals adjust electric fields associated with an array of pixels on the thin-film transistor layer. The electric field pattern that is produced controls the liquid crystal material and creates a visible image on the display.

Displays include gate driver circuitry for controlling signals on the gate lines. In some displays, gate driver circuitry is implemented using gate-on-array technology in which thin-film transistors are fabricated on the same substrate as the pixels. Challenges arise when implementing variable refresh rate schemes in displays, particularly when gate driver circuitry is implemented using thin-film transistors. If care is not taken, transistors in the gate driver circuitry may be overly stressed, which may compromise display reliability.

It would therefore be desirable to be able to provide improved electronic device displays.

### SUMMARY

An electronic device display may have an array of display pixels that are controlled using a grid of data lines and gate lines. Gate driver circuitry may be used to drive gate line signals onto the gate lines. The array of display pixels may have rows. Each row of the array of display pixels may receive gate lines signals on a respective gate line. The gate lines signals may be used to control the charging of the display pixels with data on the data lines.

The array of display pixels and the gates lines in the device may define an active display area. Each gate line may be coupled to a logic gate in a corresponding active row of the gate driver circuitry. The active row logic gates may each be coupled to a respective active row latch.

A termination block may contain gate driver circuitry that is not coupled to any of the display pixels in the array. The termination block may be formed in an inactive portion of the display and may have a termination block latch and a termination block logic gate.

Signal lines may be used to distribute clock signals from display driver circuitry to the active row logic gates. Respective signal lines may also be used to distribute a pixel charging initiation signal to a first of the active row latches and a pixel charging termination signal to the termination block latch.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative electronic device with a display such as a portable computer in accordance with an embodiment of the present invention.

FIG. 2 is a diagram of an illustrative electronic device with a display such as a cellular telephone or other handheld device in accordance with an embodiment of the present invention.

FIG. 3 is a diagram of an illustrative electronic device with a display such as a tablet computer in accordance with an embodiment of the present invention.

FIG. 4 is a diagram of an illustrative electronic device with a display such as a computer monitor with a built-in computer in accordance with an embodiment of the present invention.

FIG. 5 is a circuit diagram showing circuitry that may be used in operating an electronic device display in accordance with an embodiment of the present invention.

FIG. 6 is a circuit diagram of an illustrative display pixel in a display in accordance with an embodiment of the present invention.

FIG. 7 is a diagram of illustrative gate driver circuitry in accordance with an embodiment of the present invention.

FIG. 8 is a diagram of an illustrative portion of a gate driver circuit in accordance with an embodiment of the present invention.

FIG. 9 is a timing diagram showing signals that may be used in controlling gate driver circuitry for an electronic device display implementing a variable refresh rate scheme in accordance with an embodiment of the present invention.

FIG. 10 is a flow chart of illustrative steps involved in operating gate driver circuitry in a display for an electronic device in accordance with an embodiment of the present invention.

### DETAILED DESCRIPTION

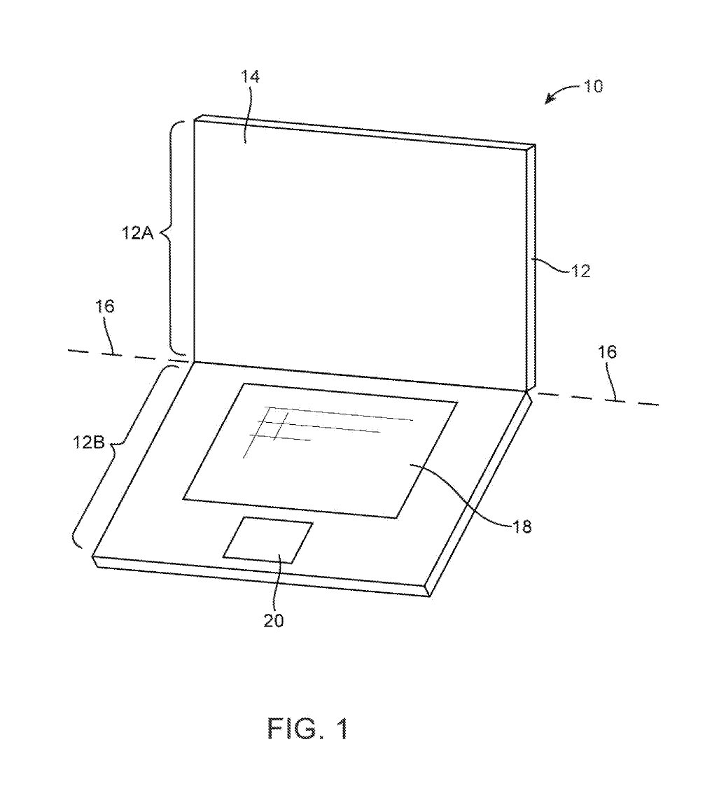

An illustrative electronic device of the type that may be provided with a display is shown in FIG. 1. Electronic device 10 may be a computer such as a computer that is integrated into a display such as a computer monitor, a laptop computer, a tablet computer, a somewhat smaller portable device such as a wrist-watch device, pendant device, or other wearable or miniature device, a cellular telephone, a media player, a tablet computer, a gaming device, a navigation device, a computer monitor, a television, or other electronic equipment.

As shown in FIG. 1, device 10 may include a display such as display 14. Display 14 may be a touch screen that incorporates capacitive touch electrodes or other touch sensor components or may be a display that is not touch sensitive. Display 14 may include image pixels formed from liquid crystal display (LCD) components or other suitable display pixel structures. Arrangements in which display 14 is formed using liquid crystal display pixels are sometimes described herein as an example. This is, however, merely illustrative. Any suitable type of display technology may be used in forming display 14 if desired.

Device 10 may have a housing such as housing 12. Housing 12, which may sometimes be referred to as a case, may be formed of plastic, glass, ceramics, fiber composites, metal (e.g., stainless steel, aluminum, etc.), other suitable materials, or a combination of any two or more of these materials.

Housing 12 may be formed using a unibody configuration in which some or all of housing 12 is machined or molded as a single structure or may be formed using multiple structures (e.g., an internal frame structure, one or more structures that form exterior housing surfaces, etc.).

As shown in FIG. 1, housing 12 may have multiple parts. For example, housing 12 may have upper portion 12A and lower portion 12B. Upper portion 12A may be coupled to lower portion 12B using a hinge that allows portion 12A to rotate about rotational axis 16 relative to portion 12B. A keyboard such as keyboard 18 and a touch pad such as touch pad 20 may be mounted in housing portion 12B.

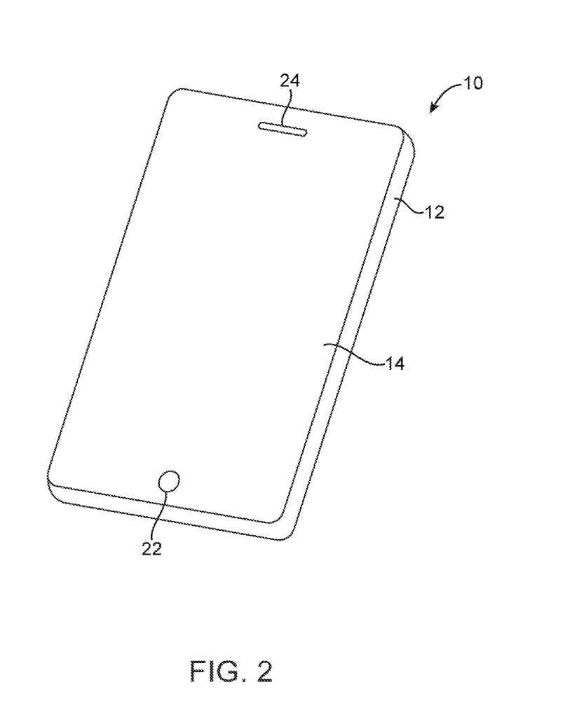

In the example of FIG. 2, device 10 has been implemented using a housing that is sufficiently small to fit within a user's hand (i.e., device 10 of FIG. 2 may be a handheld electronic device such as a cellular telephone). As show in FIG. 2, device 10 may include a display such as display 14 mounted on the front of housing 12. Display 14 may have an active area surrounded by an inactive border region (as an example). Display 14 may have openings (e.g., openings in the inactive or active portions of display 14) such as an opening to accommodate button 22 and an opening to accommodate speaker port 24.

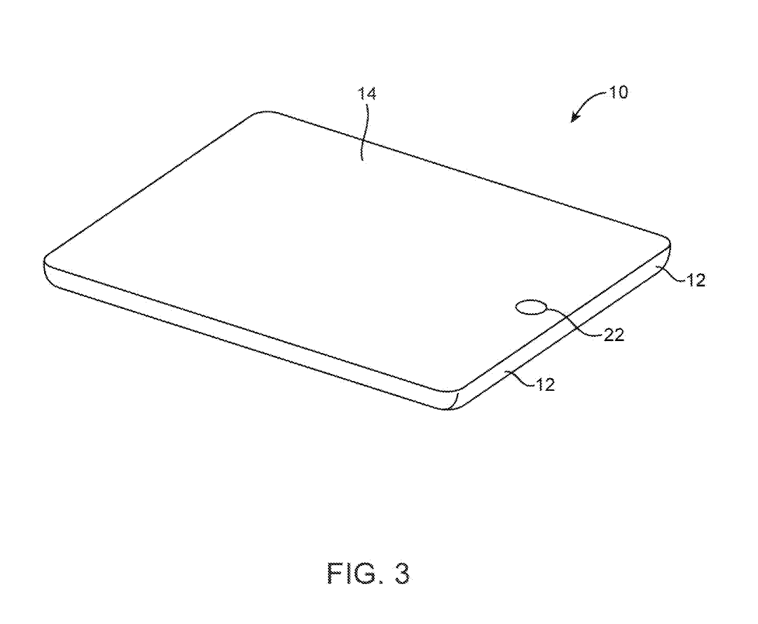

FIG. 3 is a perspective view of electronic device 10 in a configuration in which electronic device 10 has been implemented in the form of a tablet computer. As shown in FIG. 3, display 14 may be mounted on the upper (front) surface of housing 12. An opening may be formed in display 14 to accommodate button 22.

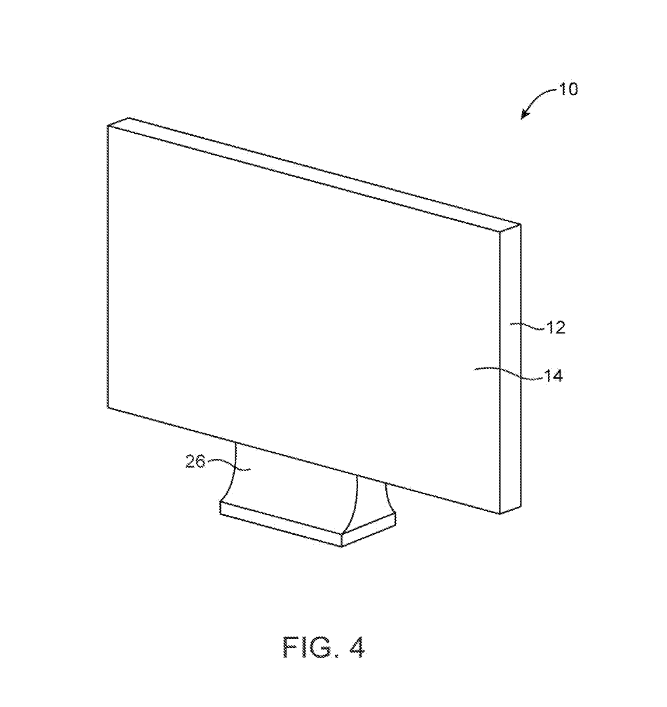

FIG. 4 is a perspective view of electronic device 10 in a configuration in which electronic device 10 has been implemented in the form of a computer integrated into a computer monitor. As shown in FIG. 4, display 14 may be mounted on the front surface of housing 12. Stand 26 may be used to support housing 12.

Other configurations may be used for electronic device 10 and display 14 if desired. The examples of FIGS. 1, 2, 3, and 4 are merely illustrative.

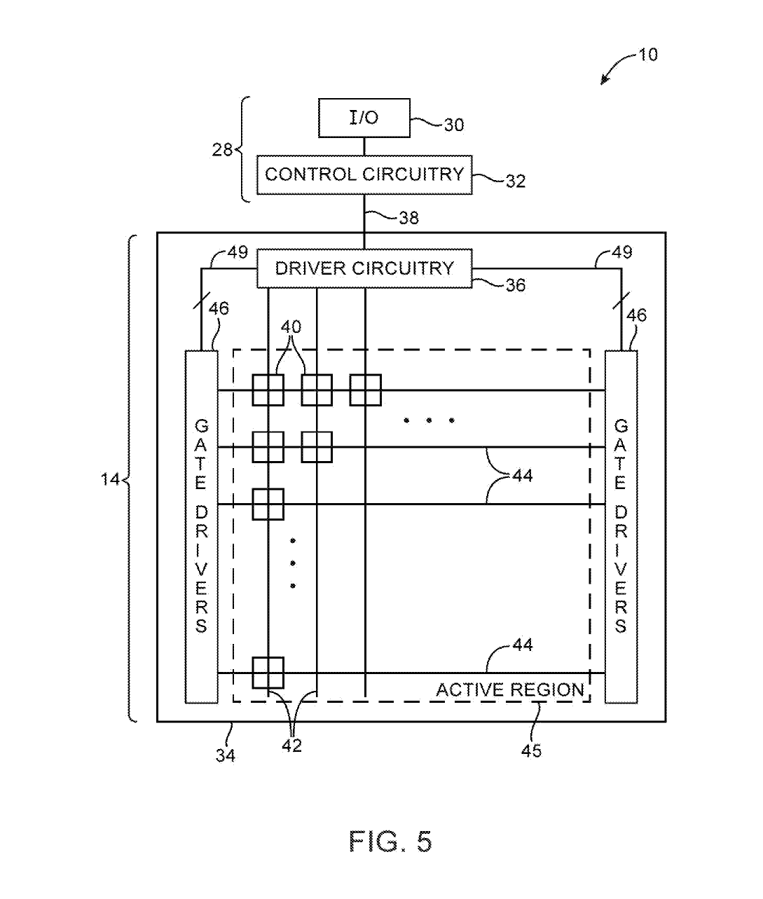

A diagram showing circuitry of the type that may be used in display 14 and device 10 is shown in FIG. 5. As shown in FIG. 5, display 14 may be coupled to device components 28 such as input-output circuitry 30 and control circuitry 32. Input-output circuitry 30 may include components for receiving device input. For example, input-output circuitry 30 may include a microphone for receiving audio input, a keyboard, keypad, or other buttons or switches for receiving input (e.g., key press input or button press input from a user), sensors for gathering input such as an accelerometer, a compass, a light sensor, a proximity sensor, touch sensor (e.g., touch sensors associated with display 14 or separate touch sensors), or other input devices. Input-output circuitry 30 may also include components for supplying output. Output circuitry may include components such as speakers, light-emitting diodes or other light-emitting devices for producing light output, vibrators, and other components for supplying output. Input-output ports in circuitry 30 may be used for receiving analog and/or digital input signal and may be used for outputting analog and/or digital output signals.

Examples of input-output ports that may be used in circuitry 30 include audio ports, digital data ports, ports associated with 30-pin connectors, 9-pin connectors, reversible connectors, and ports associated with Universal Serial Bus connectors and other digital data connectors.

Control circuitry 32 may be used in controlling the operation of device 10. Control circuitry 32 may include storage circuits such as volatile and non-volatile memory circuits, solid state drives, hard drives, and other memory and storage circuitry. Control circuitry 32 may also include processing circuitry such as processing circuitry in a microprocessor or other processor. One or more integrated circuits may be used in implementing control circuitry 32. Examples of integrated circuits that may be included in control circuitry 32 include microprocessors, digital signal processors, power management units, baseband processors, microcontrollers, application-specific integrated circuits, circuits for handling audio and/or visual information, and other control circuitry.

Control circuitry 32 may be used in running software for device 10. For example, control circuitry 32 may be configured to execute code in connection with the displaying of images on display 14 (e.g., text, pictures, video, etc.).

Display 14 may include a pixel array such as pixel array 34. Pixel array 34 may be controlled using control signals produced by display driver circuitry such as display driver circuitry 36. Display driver circuitry 36 may be implemented using one or more integrated circuits (ICs) and may sometimes be referred to as a driver IC, display driver integrated circuit, or display driver. Pixel array 34 may be formed from thin-film transistor circuitry on a substrate such as a layer of glass. The glass layer may sometimes be referred to as a thin-film transistor layer or thin-film transistor substrate layer. A display driver integrated circuit for circuitry 36 may be mounted on an edge of the thin-film transistor substrate (as an example).

During operation of device 10, control circuitry 32 may provide data to display driver 36. For example, control circuitry 32 may use a path such as path 38 to supply display driver 36 with digital data corresponding to text, graphics, video, or other images to be displayed on display 14. Display driver 36 may convert the data that is received on path 20 into signals for controlling the pixels of pixel array 34. The signals for controlling the pixels of pixel array 34 may be provided to gate driver circuitry such as gate driver circuitry 46 using paths such as paths 49.

Pixel array 34 may contain rows and columns of display pixels 40 that collectively form an active display region 45 (sometimes referred to as the active area of display 14). Gate driver circuitry 46 and driver circuitry 36 may be located in an inactive border region surrounding active display region 45. The circuitry of pixel array 34 may be controlled using signals such as data line signals on data lines 42 and gate line signals on gate lines 44.

Pixels 40 in pixel array 34 may contain thin-film transistor circuitry such as polysilicon transistor circuitry, amorphous silicon transistor circuitry, or oxide-based transistor circuitry (e.g., InGaZnO transistors) and associated structures for producing electric fields across liquid crystal material in display 14. The thin-film transistor structures that are used in forming pixels 40 may be located on a substrate (sometimes referred to as a thin-film transistor layer or thin-film transistor substrate). The thin-film transistor (TFT) layer may be formed from a planar glass substrate, a plastic substrate, or a sheet of other suitable substrate materials.

Gate driver circuitry 46 may be used to generate gate signals on gate lines 44. Circuits such as gate driver circuitry 46 may be formed from thin-film transistors on the thin-film transistor layer (e.g., from polysilicon transistor circuitry, amorphous silicon transistor circuitry, or oxide-based transistor circuitry such as InGaZnO transistors). For example, if the thin-film transistors of display pixels 34 are formed from InGaZnO transistors, the thin-film transistors of gate driver circuitry 46 may also be formed form InGaZnO transistors. Gate driver circuitry 46 may be located on both the left and right sides of pixel array 34 (as shown in FIG. 5) or may be located on only one side of pixel array 34.

The data line signals in pixel array 34 carry analog image data (e.g., voltages with magnitudes representing pixel brightness levels). During the process of displaying images on display 14, display driver circuitry 36 may receive digital data from control circuitry 32 via path 38 and may provide corresponding data signals to paths 42. The data line signals on data lines 42 may be provided to the columns of display pixels 40 in pixel array 34. Gate line signals may be provided to the rows of pixels 40 in pixel array 34 by gate driver circuitry 46 using respective gate lines 44.

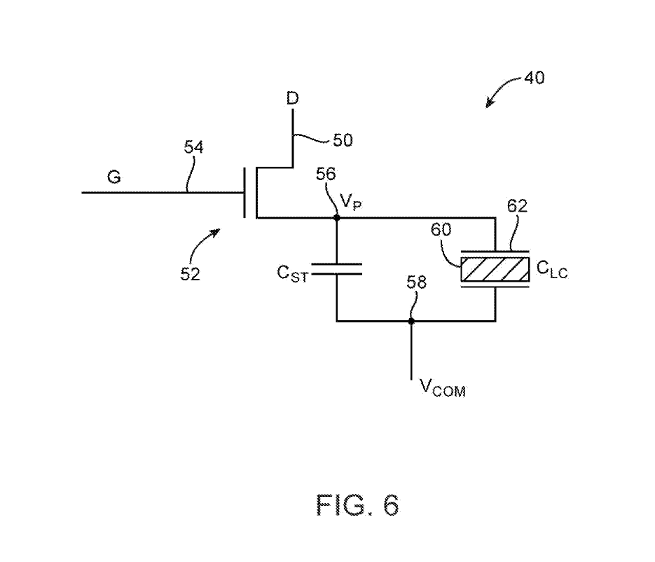

FIG. 6 is a circuit diagram of an illustrative display pixel in pixel array 34. Pixels such as pixel 40 of FIG. 6 may be located at the intersection of each gate line 44 and data line 42 in array 34.

A data signal D may be supplied to terminal 50 from one of data lines 42 (FIG. 5). Thin-film transistor 52 may have a gate terminal such as gate 54 that receives gate line signal G from gate driver circuitry 46 (FIG. 5). When signal G is asserted, transistor 52 will be turned on and signal D will be passed to node 56 as voltage Vp. Data for display 14 may be displayed in frames. Following assertion of signal G in one frame, signal G may be deasserted. Signal G may then be asserted to turn on transistor 52 and capture a new value of Vp in a subsequent display frame.

Display 14 may have a common electrode coupled to node 58. The common electrode (which is sometimes referred to as the Vcom electrode) may be used to distribute a common electrode voltage such as common electrode voltage Vcom to nodes such as node 58 in each pixel 40 of array 24. Pixel 40 may have a signal storage element such as capacitor Cst or other charge storage element. Capacitor Cst may be coupled between nodes 56 and 58. A parallel capacitance Clc arises across nodes 56 and 58 due to electrode structures in pixel 40 that are used in controlling the electric field through the liquid crystal material of the pixel (liquid crystal material 60). As shown in FIG. 6, electrode structures 62 may be coupled to node 56. Capacitance Clc is associated with the capacitance between electrode structures 62 and common electrode Vcom at node 58.

Data lines D and the gate line signals on gate lines 44 (which are coupled to gates such as gate G of FIG. 6) are used to charge pixels 40 (e.g., capacitance Cst and Clc). Once a pixel 40 has been charged, electrode structures 62 may apply a controlled electric field (i.e., a field having a magnitude proportional to Vp-Vcom) across a pixel-sized portion of liquid crystal material 60 in pixel 40. The capacitance associated with storage capacitor Cst may be used in storing signal Vp between frames (i.e., in the period of time between the assertion of successive signals G). Due to the presence of storage capacitor Cst (and capacitance Clc), the value of Vp (and therefore the associated electric field across liquid crystal material 60) may be maintained across nodes 56 and 58 for the duration of each frame.

To conserve power, display 14 may use a variable refresh rate scheme in which charge is stored on the capacitance of display pixel 40 for an extended period of time by lengthening the size of the frame (e.g., using a 30 Hz frame rate rather than a 60 Hz frame rate). In this type of arrangement, capacitances Cst and Clc may be selected to maintain the state of each display pixel 40 over the longest desired frames.

The electric field that is produced across liquid crystal material 60 causes a change in the orientations of the liquid crystals in liquid crystal material 60. This changes the polarization of light passing through liquid crystal material 60. The change in polarization may be used in controlling the amount of light that is transmitted through each pixel 40 in array 34.

Frames of data are displayed on display 14 using a series of clock pulses. After each frame of data has been displayed (i.e., after the clock pulses have been used to load each of the rows of display pixels in the active area of the display), the clock pulses are suspended for a vertical blanking interval. To help minimize power consumption in display 14, it may desirable to implement a variable refresh rate scheme for display 14. When a variable refresh rate is used, the refresh rate for the frames of data may be lowered from a frequency of 60 Hz to 30 Hz (as an example). When lowering the refresh rate, the vertical blanking interval may be extended, allowing power consumption to be lowered.

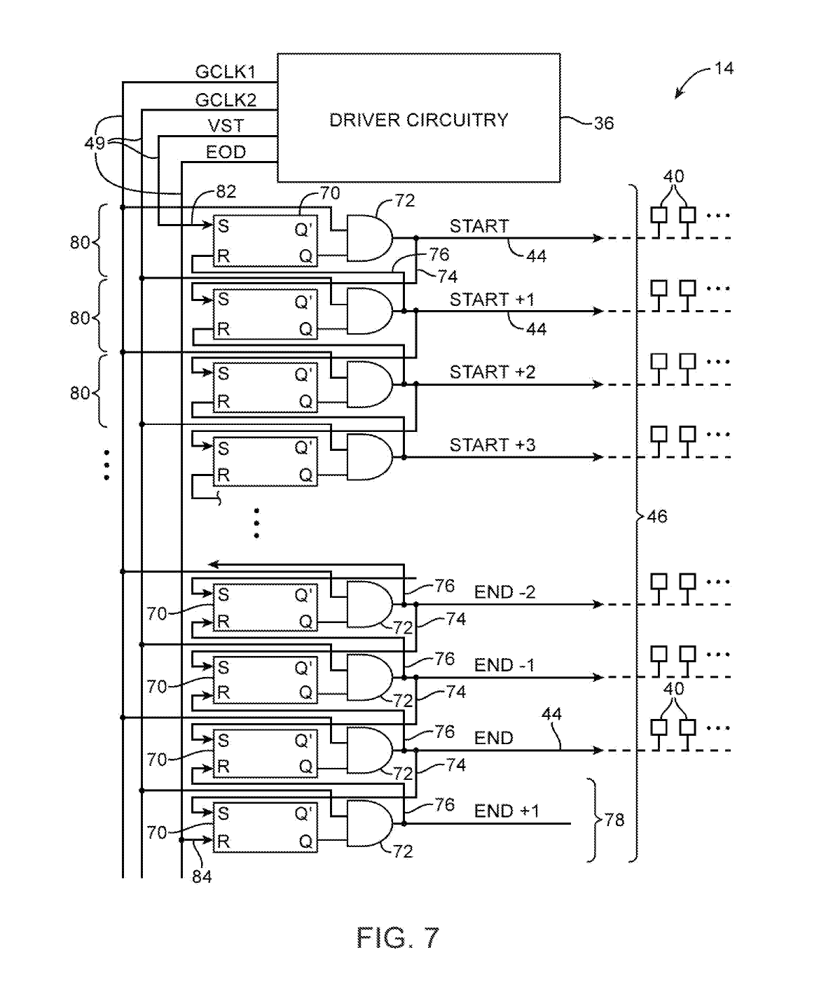

If care is not taken, thin-film transistors in display 14 may be subjected to stress during the vertical blanking interval (e.g., by applying undesirably long static gate control signals to gate structures in the thin-film transistors of the gate driver circuitry). These stresses to the thin-film circuitry of display 14 may be avoided using gate driver circuitry 46 of the type shown in FIG. 7.

In the illustrative configuration of FIG. 7, gate driver circuitry 46 is located on the left hand edge of display 14 and receives control signals VST, EOD, GCLK1, and GCLK2 from display driver circuitry 36 via control paths 49. There are two clock signals (GCLK1 and GCLK2) in the example of FIG. 7. If desired, different numbers of clock signals may be used in display 14 (e.g., four, six, eight, or more). The use of larger numbers of clock signals reduces clock frequencies, but requires correspondingly larger numbers of clock line paths in paths 49.

Gate driver circuitry 46 contains gate drivers 80 for driving gate control signals onto gate lines 44. In active area rows START to END (sometimes referred to as active rows), gate drivers 80 are coupled to respective gate lines 44. Each gate driver 80 includes a respective SR latch 70 and a respective logic gate such as an AND gate 72. Each gate line 44 may receive an output from a respective one of AND gates 72. Latches 70 and AND gates 72 are connected to form a chain using paths such as lines 74 and lines 76.

Each of lines 74 couples an AND gate output in the gate driver of a row to the set (S) input of the latch for the gate driver in the next row. The signal chain formed by gate drivers 80 and paths 74 allows an asserted gate line signal in one row to cascade down through the entire chain of gate drivers in gate driver circuitry 46 (i.e., the gate line signal goes high in one row after another through the entire display pixel array).

When a new frame of data is to be displayed, pixel charging initiation signal VST (sometimes referred to as a frame initiation signal or data loading initiation signal) is asserted by driver circuitry 36. Initiation signal VST is applied to the S input of latch 70 in the gate driver 80 in the first row (i.e., to the set terminal of the first row latch) using frame initiation signal path 82. This causes the output of AND gate 72 in the first row to be asserted. Due to the presence of lines 74, each of which routes the output of the gate driver in one row to the S input of the gate driver latch in the next row, the assertion of the output of AND gate 72 in the first row causes the gate driver in the second row to assert its output. The asserted output of the second row is passed to the S input of the latch in the third row to cause the third row output to be asserted and so forth until the gate output signal of each gate driver 80 has been asserted. The application of the pixel charging initiation signal VST to the set terminal of the latch 70 for the first row of the pixel array therefore initiates pixel charging (i.e., loading the array with a frame of data) by initiating the cascading of the asserted gate line signal through each of the rows.

Lines 76 are used for resetting each gate driver 80 after the output of the subsequent row has been asserted. For example, when the output of the gate driver in the second row is asserted, the line 76 that is coupled between the first and second rows is used to feed back a reset signal to the reset (R) input of the latch 70 in the first row. Each time a row's output is asserted, a respective line 76 is used to pass a reset signal to the previous row, so that the previous row's output is deasserted.

The outputs of the latches 70 in the active portion of display 14 (i.e., the outputs of the active row latches ranging from first row latch in row START to last row latch in row END) are each coupled to a gate line 44 that is connected to an associated row of display pixels in the display pixel array. Termination block 78 (sometimes referred to as a termination gate driver) has an output (END+1) that is floating and not coupled to any of the display pixels in display 14.

As shown in FIG. 7, the rows of display pixels 40 in active region 45 start with the first row of the pixel array (START) and end with the last row of the pixel array (END). Termination block 78 is formed in the inactive portion of display 14 and does not control a gate line or any display pixels 40 in active region 45. In each of the active rows of the display (i.e., in each of the rows of the display that is coupled to a row of display pixels such as the rows ranging from the first row that contains the first active row latch to the last row that contains the last active row latch), a corresponding active row logic gate such as an active row AND gate 72 is used in supplying a gate line signal to a respective gate line 44. In termination block 78, termination block AND gate 72 produces an output that is used in resetting the last row latch (i.e., the latch in row END), but that is not supplied to a gate line.

FIG. 7 shows how termination block 78 has an output that is coupled to the reset R input of the latch 70 in the previous row (i.e., the last row latch 70 which is in row END and which is associated with the last row in the active area of display 14). When all data for a frame has been displayed on the display pixels of display 14 (i.e., when charging of the capacitance of each display pixel 40 has been completed so that all data for the frame has been loaded and so that the gate line signal at the output of last row END has been asserted), display driver circuitry 36 may assert an end-of-data signal such as signal EOD (sometimes referred to as pixel charging termination signal EOD. Signal EOD may be applied to the reset terminal in the termination block latch 70 of the termination block using end-of-data path 84 to reset the termination block latch 70. Signal EOD may be asserted in this way at the end of the pixel charging process in each frame.

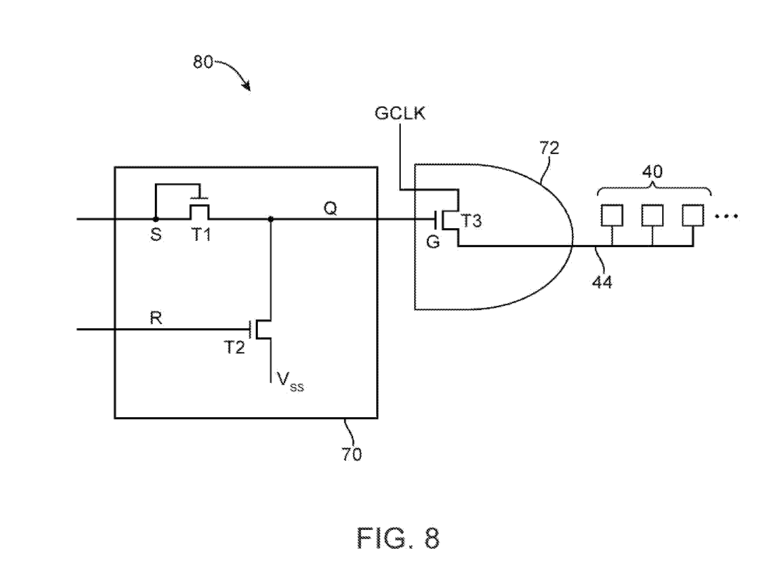

FIG. 8 is a circuit diagram of an illustrative gate driver 80. If desired, additional transistors and circuitry may be incorporated into each gate driver in gate driver circuitry 46. The example of FIG. 8 is merely illustrative.

As shown in FIG. 8, set-reset latch 70 may contain transistors such as transistors T1 and T2. Transistor T2 may have a terminal coupled to ground Vss. Transistor T3 is used to form AND gate 72. The Q output of latch 70 may be supplied to the gate of transistor T3, which forms a first input to AND gate 72. Clock signal GCLK (e.g., clock GCLK1 or GCLK2 in a two clock system) is applied to a second input of AND gate 72. The output of AND gate 72 is coupled to gate line 44.

Termination block 78 may use circuitry of the type shown in FIG. 8. Because termination block 78 does not receive a reset signal from a subsequent row of gate driver circuitry, termination block 78 relies on reset signals from path 84. By ensuring that end-of-data signal EOD is applied to reset input R of the latch in the termination block by EOD path 84, gate driver circuitry 46 can ensure that the latch in the termination block will be reset immediately following the charging of the display pixels in active region 45. In the absence of the EOD signal, the value Q of the output of SR latch 70 in termination block 78 would remain high for the entire width of the vertical blanking interval (i.e., the width of the variable refresh rate extended vertical blanking interval in a situation in which the refresh rate of the display has been slowed). The high Q value would hold the gate G of transistor T3 in the AND gate 72 of the termination block high for a potentially lengthy period of time, thereby stressing transistor T3 and giving rise to potential reliability failures of circuitry 46. By using the EOD signal, the SR latch 70 in the termination block 78 is promptly reset, so that transistor T3 is not stressed.

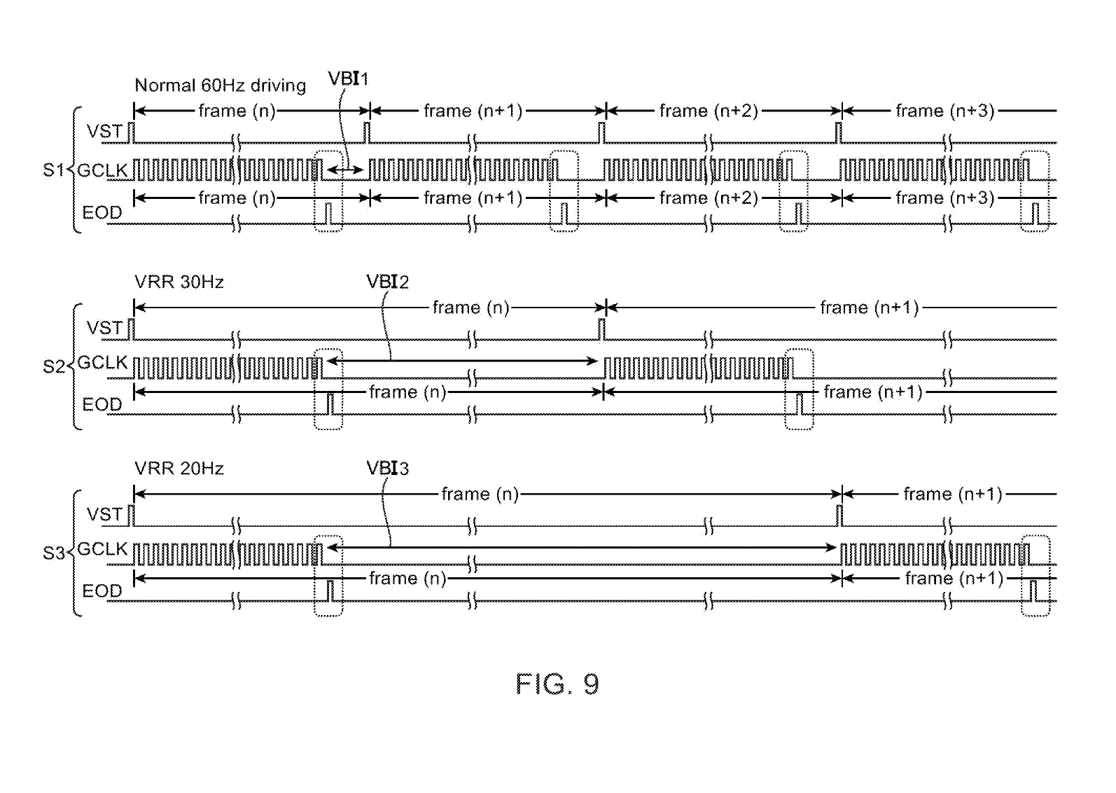

FIG. 9 is a timing diagram showing signals involved in controlling display 14 in three different refresh rate scenarios. Signal GCLK corresponds to signal GCLK1 (signal GCLK2 may be an inverted version of GCLK1 in a two-clock arrangement). Signal VST is asserted when pixel charging begins, so that gate driver circuitry 46 will produce a sequence of asserted gate line signals on gate lines 44, as described in connection with FIG. 7. Once a frame of data for the pixels 40 in pixel array 34 has been loaded into pixel array 34 using the gate line signals, the clock signals may be halted and end of data signal EOD may be asserted to reset the latch 70 in the termination gate driver (i.e., termination block 78 of FIG. 7) and thereby ensure that the gate of the transistor in the AND gate of the termination gate driver (i.e., transistor T3 in termination block 78) is not subjected to a prolonged asserted signal Q from latch 70. An EOD signal line in path 49 and path 84 are used to route the EOD signal to the reset terminal of latch 70.

Following the halting of the clock signals and the assertion of the EOD signal to reset latch 70 in the termination block, the clock is held in a stopped condition for a vertical blanking interval. In scenario S1, a refresh rate (frame rate) of 60 Hz is used and the length of vertical blanking interval VBI1 is relatively small. When the refresh rate is reduced to 30 Hz using a variable refresh rate scheme (scenario S2), an extended vertical blanking interval VBI2 is produced, during which the clock signals are disabled and no pixel charging in array 34 takes place. Because the gate driver circuitry is quiescent during extended vertical blanking interval VBI2, power can be conserved in display 14. In scenario S3, the display refresh rate has been reduced further to 20 Hz using a variable refresh rate scheme. In scenario S3, an even longer extended vertical blanking interval VBI3 is produced, conserving more power. Even in extended vertical blanking interval scenarios in which the length of the vertical blanking interval is tens of milliseconds in length, the resetting of latch 70 in termination block 78 will prevent damage to gate G of transistor T3 in AND gate 72 in the termination block, thereby helping to avoid reliability issues from overstressing transistor T3.

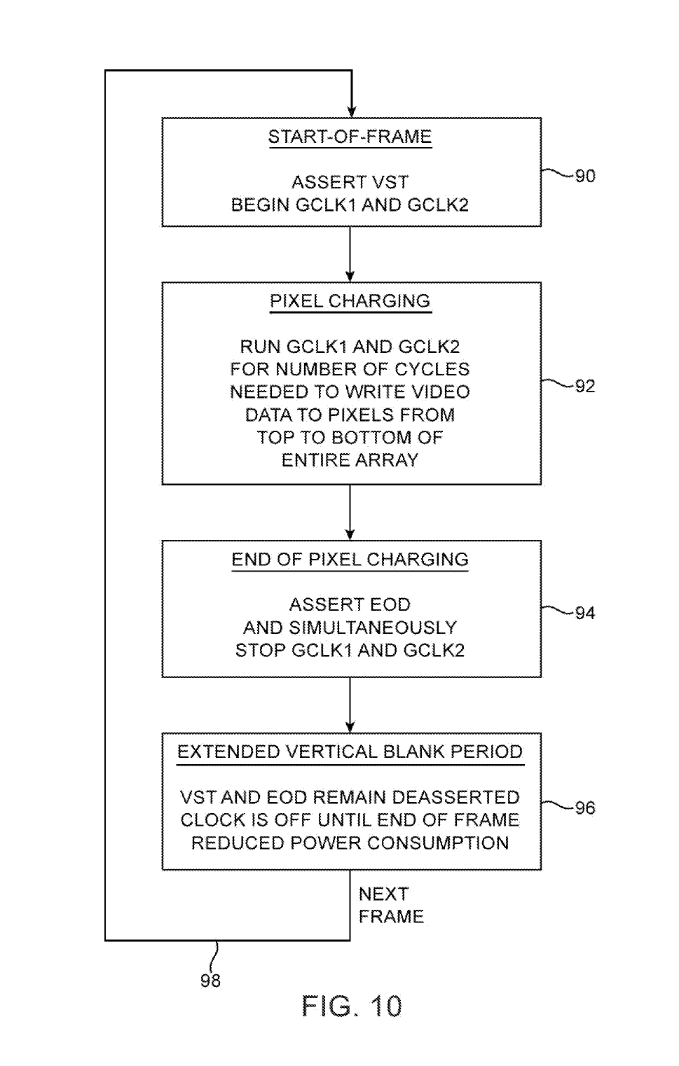

Illustrative steps involved in operating a display using gate driver circuitry such as gate driver circuitry 46 of FIG. 7 are shown in FIG. 10.

At step 90 (start of frame operations), display driver circuitry 36 starts the clock signals on the clock lines in path 49. For example, in a two-clock system such as the system of FIG. 7, display driver circuitry 36 begins generating clock signals GCLK1 and GCLK2. Using respective clock signal lines in path 49, these signals are applied to logic gates in alternating gate driver circuits 80 of gate driver circuitry 46, as shown in FIG. 7. For example, the GCLK1 clock is applied to the AND gates 72 in odd rows and the GCLK2 clock is applied to the AND gates 72 in even rows. Display driver circuitry 36 also asserts signal VST to begin pixel charging.

During the operations of step 92 (pixel charging), display driver circuitry 36 runs the clock signals (e.g. clock signals GCLK1 and GCLK2) for a sufficient number of cycles to load video data (display pixel data) from data lines 42 into all of the pixels 40 of array 34. During each clock cycle, the gate line in a given row is asserted and the gate line in the previous row is deasserted. After the gate line signal has been asserted in each active row of the array (i.e., each active area row), pixel charging is complete.

To ensure that the termination block is properly reset, display driver circuitry 36 may then assert end-of-data signal EOD to reset the latch in the gate driver circuit of the termination block in the inactive portion of the display (end of pixel charging step 94). Display driver circuitry 36 asserts the EOD signal after the termination block has reset the latch in the last active row of the display (row END of FIG. 7).

At step 96, display 14 maintains the clocks in a stopped state until a desired vertical blanking interval has been completed. Display 14 may use a variable refresh rate (VRR) scheme. With this type of scheme, slowing the refresh rate (i.e., the frequency with which frames of data are refreshed in pixels 40 of display pixel array 34) provides more time for the vertical blanking interval. When the refresh rate is slowed sufficiently, entire data frames (i.e., data frames at the nominal refresh rate) may be skipped, as shown in FIG. 9. This conserves power due to the omission of the associated pixel charging operations. During the extended vertical blanking intervals, both the VST and EOD signals remain deasserted by display drive circuitry 36. Processing may then loop back to step 90, as indicated schematically by line 98 of FIG. 10.

The foregoing is merely illustrative of the principles of this invention and various modifications can be made by those skilled in the art without departing from the scope and spirit of the invention.

What is claimed is:

1. A display, comprising:
an array of display pixels having rows;
display driver circuitry;
gate driver circuitry having a plurality of active row latches each of which generates a gate line signal for a respective one of the rows, wherein the active row latches that generate the gate line signals for the rows include a first row latch associated with a first of the rows and a last row latch associated with a last of the rows and wherein the gate driver circuitry includes a termination block latch that is coupled to the last row latch;
clock signal lines that distribute clock signals from the display driver circuitry to the gate driver circuitry;
a first signal line that distributes a pixel charging initiation signal from the display driver circuitry to a set terminal of the first row latch; and
a second signal line that distributes a pixel charging termination signal from the display driver circuitry to a reset terminal of the termination block latch.

2. The display defined in claim 1 wherein the display pixels each include a thin-film transistor.

3. The display defined in claim 2 wherein the gate driver circuitry comprises thin-film transistors.

4. The display defined in claim 3 wherein the thin-film transistors of the gate driver circuitry include InGaZnO transistors.

5. The display defined in claim 1 wherein the gate driver circuitry includes a plurality of active row logic gates having inputs coupled to outputs of the active row latches and includes a termination block logic gate coupled to the output of the termination block latch.

6. The display defined in claim 5 wherein the active row logic gates comprise active row AND gates and wherein the termination block logic gate comprises a termination block AND gate.

7. The display defined in claim 6 wherein each of the active row AND gates has an output that produces a respective one of the gate line signals.

8. The display defined in claim 7 wherein the termination block AND gate has an output that is coupled to a reset terminal of the last row latch.

9. The display defined in claim 1 wherein the rows include even rows and odd rows and wherein the clock signal lines include a first clock signal line that is coupled to latch set terminals in the active row latches in the even rows and a second clock signal line that is coupled to latch set terminals in the active row latches in the odd rows.

10. A method of operating a display having an array of display pixels with rows, comprising:
with display driver circuitry, initiating pixel charging of the array of display pixels with gate driver circuitry by providing a pixel charging initiation signal to the gate driver circuitry on a first signal line;
with the display driver circuitry, conveying clock signals to the gate driver circuitry on at least second and third signal lines to charge the array of display pixels with the gate driver circuitry using the clock signals following initiation of pixel charging; and
with the display driver circuitry, terminating pixel charging of the array of display pixels by providing a pixel charge termination signal to the gate driver circuitry on a fourth signal line after the rows in the array of display pixels have been charged.

11. The method defined in claim 10 wherein the gate driver circuitry includes a plurality of active row latches each associated with a respective row in the array of display pixels and includes a termination block latch, and wherein terminating pixel charging comprises resetting the termination block latch by providing the pixel charging termination signal to a reset terminal of the termination block latch.

12. The method defined in claim 11 further comprising:
after terminating pixel charging by providing the pixel charging termination signal, stopping the use of the clock signals for pixel charging for a variable refresh rate extended vertical blanking interval.

13. A display, comprising:
an array of display pixels having rows with respective gates lines;
gate driver circuitry including a plurality of active row latches and active row logic gates, wherein each active row latch is coupled to a respective one of the gate lines through a respective one of the active row logic gates and wherein the gate driver circuitry includes a termination block latch;
display driver circuitry; and
at least first and second signal lines coupled between the display driver circuitry and the gate driver circuitry, wherein the display driver circuitry is configured to provide a first signal to a set terminal of one of the active row latches over the first signal line and is configured to provide a second signal to a reset terminal of the termination block latch over the second signal line.

14. The display defined in claim 13 further comprising a termination block logic gate having an input that receives an output signal from the termination block latch.

15. The display defined in claim 14 wherein the termination block logic gate has an output that is coupled to a reset terminal of one of the active row logic gates.

16. The display defined in claim 15 wherein the gate driver circuitry comprises thin-film transistors.

17. The display defined in claim 16 further comprising at least two clock lines with which the display driver circuitry provides clock signals to the active row logic gates and the termination block logic gate.

18. The display defined in claim 17 wherein the rows include even rows and odd rows, wherein the clock lines include at least a first clock line and a second clock line, wherein the first clock line is coupled to the active row logic gates in the odd rows, and wherein the second clock line is coupled to the active row logic gates in the even rows.

19. The display defined in claim 13 further comprising a termination block logic gate, wherein the termination block logic gate has an input that receives a clock signal from the display driver circuitry.

20. The display defined in claim 19 wherein the termination block logic gate comprises an AND gate with an output coupled to a latch reset terminal.
